(19) United States
(12) Patent Application Publication
(10) Pub. No.: US 2026/0235814 A1
(43) Pub. Date: Aug. 13, 2026

(54) OPTICAL CONNECTION COMPONENT

(71) Applicant: SUMITOMO ELECTRIC INDUSTRIES, LTD, Osaka-shi, Osaka (JP)

(72) Inventors: Tetsuya NAKANISHI, Osaka (JP); Hajime ARAO, Osaka (JP)

(73) Assignee: SUMITOMO ELECTRIC INDUSTRIES, LTD, Osaka-shi, Osaka (JP)

(21) Appl. No.: 19/148,107

(22) PCT Filed: Jan. 18, 2024
(86) PCT No.: PCT/JP2024/001326

§ 371 Date: Jul. 15, 2025

(30) Foreign Application Priority Data
Feb. 17, 2023 (JP) 2023-023501

(51) Int. Cl. G02B 6/32; G02B 6/26; G02B 6/36; G02B 6/38

(52) U.S. Cl. CPC G02B 6/327; G02B 6/262; G02B 6/264; G02B 6/3608; G02B 6/3882; G02B 6/3885

(57) ABSTRACT

An optical connection component relates to an optical connection component having a structure for reducing optical coupling loss between external devices constituted by materials having differing thermal expansion coefficients. The optical connection component is provided with a glass substrate and a lens. The glass substrate has a first substrate end surface, a second substrate end surface, and a core, and includes a glass material transparent to the wavelength of light propagating through the core. The lens is disposed on the surface of the glass substrate in a state of being optically coupled to the core.

### TECHNICAL FIELD

The present disclosure relates to an optical connection component. This application claims priority from Japanese Patent Application No. 2023-023501 filed on Feb. 17, 2023, and the content of which is relied upon and incorporated herein by reference in its entirety.

### BACKGROUND ART

As an optical component functioning as an optical connection component, Patent Literature 1 discloses a resin-molded ferrule. The ferrule is provided with a positioning structure and a lens holding structure for stably holding a plurality of optical fibers.

### CITATION LIST

### Patent Literature

Patent literature 1: U.S. Patent Application Publication No. 2021/149127 A1

### Non Patent Literature

Non-patent literature 1: Y. Nasu, et al. “Low-loss waveguides written with a femtosecond laser for flexible interconnection in a planar light-wave circuit”, OPTICS LETTERS Vol. 30, No. 7, Apr. 1, 2005

### SUMMARY OF INVENTION

An optical connection component of the present disclosure includes a glass substrate in which one or more cores are formed inside, and one or more first lenses. The glass substrate has a first substrate end surface and a second substrate end surface located opposite to the first substrate end surface and includes one or more cores arranged between the first substrate end surface and the second substrate end surface. The glass substrate is made of a glass material transparent to a wavelength of light propagating through each of the cores. The one or more first lenses are provided in one-to-one correspondence with the cores and are arranged on a surface of the glass substrate in a state in which each of the first lenses is optically coupled to a corresponding one of the cores.

### BRIEF DESCRIPTION OF THE DRAWINGS

FIG. 1 is a diagram for explaining various implementation examples of an optical connection component of the present disclosure.

FIG. 2 is a diagram showing examples of typical cross-sectional structures of an optical connection component of the present disclosure.

FIG. 3 is a diagram for explaining a manufacturing apparatus and a scanning operation for manufacturing an optical connection component of the present disclosure.

FIG. 4 is a diagram for explaining a cross-sectional structure around a core in an optical connection component obtained by the manufacturing apparatus shown in FIG. 3.

FIG. 5 is a diagram showing a first modification of an optical connection component of the present disclosure and a core arrangement thereof.

FIG. 6 is a diagram showing a second modification of an optical connection component of the present disclosure and a core arrangement thereof.

FIG. 7 is a diagram showing a third modification of an optical connection component of the present disclosure and a core arrangement thereof.

FIG. 8 is a diagram showing a core shape of each of a fourth modification to a sixth modification of an optical connection component of the present disclosure.

FIG. 9 is a diagram showing a seventh modification of an optical connection component of the present disclosure and a core arrangement thereof.

FIG. 10 is a diagram for explaining another implementation example of an optical connection component of the present disclosure.

### DETAILED DESCRIPTION

### Problems to be Solved by Present Disclosure

The inventors have studied the above-described conventional techniques and have found the following problems. That is, the resin ferrule of Patent Literature 1 has a large thermal expansion coefficient, and thus the beam position is highly dependent on temperature. Thus, when an external device and the optical fibers are optically coupled in a state where the resin ferrule is directly mounted on the external device which may be a heat source, there has been a problem that optical coupling loss increases with the temperature rise of the external device. Specifically, a thermal expansion coefficient of PEI (Poly Ether Imide), which is a resin molding material used at optical communication wavelengths of 1.310 μm and 1.550 μm, is 4.7×10⁻⁵/° C. to 5.6×10⁻⁵/° C. In contrast, a thermal expansion coefficient of Si used in the SiPh (silicon photonics) technology is around 2.5×10⁻⁶/° C. When the two are compared, the thermal expansion coefficients are different by an order of magnitude. Thus, when a resin ferrule fixed to tips of optical fibers is directly mounted on a Si-based external device such as an optical IC substrate manufactured by the SiPh technology, there is a high possibility that optical output positions on the external device and optical input/output positions of the resin ferrule are shifted due to a temperature change. That is, a difference in thermal expansion coefficient between the objects to be coupled has been a cause of an increase in optical coupling loss. In particular, when the number of optical input/output channels to be connected, that is, the number of cores, increases, the size of the resin ferrule itself increases, and thus, such a problem caused by the difference in thermal expansion coefficient becomes significant in an optical connection component having a certain number of cores or more.

Further, when light is deflected at a right angle as in the resin ferrule of Patent Literature 1, that is, when the direction in which light travels is bent by 90 degrees, there is also a problem that it is difficult to arrange lenses two-dimensionally. Specifically, when a positioning structure for optical fibers is provided in the resin ferrule, it is necessary to arrange holes for insertion of the optical fibers two-dimensionally. However, it is extremely difficult to flexibly change terminal end positions at which optical coupling end faces of the optical fibers to be inserted are arranged for each row because the shape of a metal mold for molding the ferrule becomes complicated. On the other hand, when the direction in which light travels is bent by 90 degrees, it is practically difficult to keep the terminal end positions of the optical fibers arranged two-dimensionally and the distances between the lenses constant and stable in the resin ferrule. As a result, it is difficult to standardize the beam focusing positions.

Further, in the resin ferrule, there is a problem that it is difficult to perform core pitch conversion between an end face close to the optical fibers and an end face close to the external device, and arrangement conversion such as conversion of the optical input/output positions from one-dimensional arrangement to two-dimensional arrangement. Specifically, when light from the terminal end position of the optical fiber is guided to the lens after positioning the optical fiber by the resin ferrule, the light propagates linearly in the resin. Thus, it is difficult to perform core pitch conversion and arrangement conversion of the optical input/output positions in the resin ferrule described in Patent Literature 1.

The present disclosure provides an optical connection component having a structure for reducing optical coupling loss between external devices made of materials having different thermal expansion coefficients.

### Advantageous Effects of Present Disclosure

According to an optical connection component of the present disclosure, it is possible to reduce optical coupling loss between external devices made of materials having different thermal expansion coefficients.

### Description of Embodiments of Present Disclosure

First, the contents of embodiments of the present disclosure will be described by listing them individually.

(1) An optical connection component of the present disclosure includes a glass substrate in which one or more cores are formed inside, and one or more first lenses. The glass substrate has a first substrate end surface and a second substrate end surface located opposite to the first substrate end surface and includes one or more cores arranged between the first substrate end surface and the second substrate end surface. The glass substrate is made of a glass material transparent to a wavelength of light propagating through each of the cores. The one or more first lenses are provided in one-to-one correspondence with the cores and are arranged on a surface of the glass substrate in a state in which each of the first lenses is optically coupled to a corresponding one of the cores.

In this manner, an optical waveguide forming region of the optical connection component of the present disclosure is made of a glass material, and thus optical coupling loss between external devices made of materials having different thermal expansion coefficients, such as a Si-based external device represented by an SiPh chip using SiPh technology such as an optical IC substrate and a resin external device such as an optical connectors made of a resin ferrule, is effectively reduced. That is, for example, a glass material having a thermal expansion coefficient one order of magnitude smaller than the thermal expansion coefficient of a resin, such as synthetic quartz or aluminosilicate glass, is applied to the optical connection component of the present disclosure. In this case, since the resin ferrule of the optical connector does not come into contact with the Si-based external device such as the optical IC substrate, thermal expansion of the resin ferrule is avoided, and the optical coupling loss between the optical IC and the optical fiber can be reduced. Further, by manufacturing the first lens by a 3D molding technique using a resin material, the lens manufacturing itself becomes easy, enabling a reduction in manufacturing costs and an increase in production volume.

(2) In the above (1), each of the cores has a shape extending from the first substrate end surface toward the second substrate end surface, a first core end surface located near the first substrate end surface, and a second core end surface located near the second substrate end surface. Each of the first core end surfaces is positioned on the first substrate end surface. Each of the second core end surfaces is positioned inside the glass substrate so as to be spaced apart from the second substrate end surface by a certain distance. Each of the first lenses is disposed on the second substrate end surface. In this manner, the first core end surface extends to the first substrate end surface, and thus it is possible to optically connect the core in the glass substrate to a general optical fiber array or an optical connector. The second core end surface is terminated inside the glass substrate, and the first lens is disposed at a position where light from the terminated second core end surface reaches. Thus, by appropriately designing a lens and a distance from the first lens to the terminal end position of the core which is an optical waveguide in the glass substrate, a beam having a desired beam quality such as a beam diameter, a beam divergence angle, and a focusing position can be obtained.

(3) In the above (1), the number of the cores may be three or more, and each of the three or more cores has a shape extending from the first substrate end surface toward the second substrate end surface, a first core end surface located near the first substrate end surface, and a second core end surface located near the second substrate end surface. The first core end surfaces are arranged two-dimensionally on the first substrate end surface when the first core end surfaces are viewed from the first substrate end surface toward the second substrate end surface. On the other hand, the second core end surfaces are arranged one-dimensionally inside the glass substrate so as to be spaced apart from the second substrate end surface by a certain distance when the second core end surfaces are viewed from the second substrate end surface toward the first substrate end surface. In the glass substrate of the optical connection component of the present disclosure, the first substrate end surface to the second substrate end surface on which the first lenses are arranged are optically connected via the cores which can be processed into any shape. Thus, it is possible to easily enable core pitch conversion and arrangement conversion such as conversion of optical input/output positions from a one-dimensional arrangement to a two-dimensional arrangement. In this manner, by using the optical connection component of the present disclosure, it is possible to achieve optical coupling between an optical connector in which optical fibers are arranged two-dimensionally as a resin external device and a Si-based external device in which optical input/output positions are arranged one-dimensionally.

(4) In the above (1), the number of the cores may be three or more, and each of the three or more cores has a shape extending from the first substrate end surface toward the second substrate end surface, a first core end surface located near the first substrate end surface, and a second core end surface located near the second substrate end surface. The first core end surfaces are arranged one-dimensionally on the first substrate end surface when the first core end surfaces are viewed from the first substrate end surface toward the second substrate end surface. On the other hand, the second core end surfaces are arranged two-dimensionally inside the glass substrate so as to be spaced apart from the second substrate end surface by a certain distance when the second core end surfaces are viewed from the second substrate end surface toward the first substrate end surface. In this configuration, the lenses on the second substrate end surface are also arranged two-dimensionally. That is, even in a configuration in which optical input/output positions of the optical connector, which is the resin external device, are arranged one-dimensionally and optical input/output positions of the Si-based external device are arranged two-dimensionally, the optical input/output positions of both the resin external device and the Si-based external device can be matched by using the optical connection component of the present disclosure.

(5) In the above (1), the number of the cores may be two or more, and each of the two or more cores has a shape extending from the first substrate end surface toward the second substrate end surface, a first core end surface located near the first substrate end surface, and a second core end surface located near the second substrate end surface. Each of the first core end surfaces is positioned on the first substrate end surface. On the other hand, each of the second core end surfaces is positioned inside the glass substrate so as to be spaced apart from the second substrate end surface by a certain distance. Further, a first core pitch that is a center-to-center distance between each adjacent pair of the first core end surfaces differs from a second core pitch that is a center-to-center distance between each adjacent pair of the second core end surfaces. As described above, by using the optical connection component of the present disclosure, even when the pitches of the optical input/output positions are different between the external devices to be optically coupled, the core pitch on the first substrate end surface and the core pitch on the terminal end position of the core located inside the glass substrate can be flexibly converted.

(6) In the above (1), the number of the cores may be three or more, and each of the three or more cores has a shape extending from the first substrate end surface toward the second substrate end surface, a first core end surface located near the first substrate end surface, and a second core end surface located near the second substrate end surface. On the other hand, the second substrate end surface is inclined with respect to the first substrate end surface. The second core end surfaces are arranged two-dimensionally inside the glass substrate so as to be spaced apart from the second substrate end surface by a certain distance when the second core end surfaces are viewed from the second substrate end surface toward the first substrate end surface and such that optical path lengths from the second core end surfaces to the respective first lenses coincide with each other. In this configuration, the “optical path length” is defined on an optical axis of light propagating between the second core end surface and the first lens. Further, each of the first lenses is disposed on the second substrate end surface, which is inclined. At this time, an inclination angle of the second substrate end surface is set so as to totally reflect the light that has reached the first lens.

When a short-pulse laser such as a femtosecond laser is used to form cores inside the glass substrate, the pitch between cores and the terminal end positions of the cores can be flexibly changed. Thus, the terminal end positions of the cores arranged two-dimensionally can be flexibly changed for each row. In addition, when the direction in which light travels is bent by 90 degrees, the distance from the terminal end positions of the cores arranged two-dimensionally to the respective first lenses can be kept constant, and the beam quality as described above can be standardized among the cores. Further, by utilizing such technical features, it is possible to form collimated light having any beam diameter while changing the optical paths from the cores arranged two-dimensionally to the perpendicular direction. By changing the distance from the terminal end position of the core to the first lens for some of the plurality of cores, the beam diameter and the focusing position can be changed to be suitable for the coupling target.

(7) In the above (1), the optical connection component may include a reflective film covering a surface of each of the first lenses, excluding a surface of each of the first lenses facing the surface of the glass substrate. In a configuration in which light is totally reflected at a surface of the first lens, refractive index difference between the inside of the lens and the lens surface may change if a foreign matter adheres to the surface of the first lens. When the refractive index difference changes on the lens surface in this manner, reflection characteristics of the first lens may change. Thus, by forming the reflective film made of a metal film or a multilayer film on an exposed surface of the first lens, stable reflection characteristics can be obtained even in actual use.

(8) In the above (1), the number of the cores may be two or more, and the number of types of the first lenses may be two or more. That is, with the configuration of the above (2), it is possible to produce a beam having any beam quality as described above. In addition, when the first lens is made of resin, it is easy to design each lens as desired by using 3D molding technique. That is, by using the optical connection component of the present disclosure, light having any beam diameter can be formed while changing the optical paths from the cores arranged two-dimensionally to the perpendicular direction. In this case, the distances from the terminal end positions of the cores to the respective first lenses do not need to be the same between the cores, and may be appropriately set for each core according to the beam diameter desired to be obtained at the terminal end position of the core. For example, inside the glass substrate, in a configuration in which the distance from the terminal end position of the core to the first lens coincides with the distance from the first lens to the bottom surface of the glass substrate and each first lens has an appropriate focal length, the beam can be focused so that the beam diameter and the mode field of the core which is a waveguide coincide with each other on the bottom surface of the glass substrate.

(9) In the above (1), the glass substrate may have a positioning structure configured to determine relative positions of the cores with respect to an external device having a structure configured to enable the external device to be optically coupled to the cores. Specifically, by providing a structure such as a guide hole or a V-groove in the glass substrate, the cores inside the glass substrate can be passively and optically coupled to the optical connector or the like, which is the resin external device.

(10) In the above (1), the first substrate end surface may be inclined in a range of 5 degrees to 20 degrees with respect to a plane perpendicular to a central axis of an end portion of each of the cores located near the first substrate end surface. In general, the core formed in the glass substrate is not easily deformed. Thus, when fitting with the optical connector or the like which is the external device made of resin, it is difficult to perform PC (physical contact) connection by pressing, and it is also difficult to reduce reflection on the first substrate end surface. Thus, by inclining both the first substrate end surface and a ferrule end surface of the optical connector in the range of 5 degrees to 20 degrees, for example, about 8 degrees, it is possible to achieve a reflection loss of 40 dB or more or a value close to it while reducing occurrence of an excessive insertion loss. In this case, the reflected light is not coupled back to each core, and the influence on propagation characteristics is effectively reduced.

(11) In the above (10), the optical connection component may include a spacer member disposed between the first substrate end surface and an external device to be optically connected to the first substrate end surface, the spacer member being configured to maintain a gap of 5 μm to 25 μm between the first substrate end surface and the external device. By combining this configuration with the configuration of the above (10), it is possible to reliably obtain a reflection loss of 40 dB or more. That is, the reflected light is not coupled back to each core, and the influence on the propagation characteristics is effectively reduced.

(12) In the above (1), the optical connection component may include an anti-reflection structure provided on the first substrate end surface. Further, each of the cores has a shape extending from the first substrate end surface toward the second substrate end surface, a first core end surface located near the first substrate end surface, and a second core end surface located near the second substrate end surface. Further, each of the first core end surfaces is positioned on the first substrate end surface with the anti-reflection structure covering each of the first core end surfaces. In the configurations of the above (10) and (11), it is difficult to obtain a reflection loss of 55 dB or more. Thus, by providing the anti-reflection structure on the first core end surfaces of the cores located on the first substrate end surface, a reflection loss of 55 dB or more can be obtained.

(13) In the above (1), the optical connection component may include one or more second lenses provided in one-to-one correspondence with the cores provided inside the glass substrate and arranged on a surface of the glass substrate in a state in which each of the second lenses is optically coupled to a corresponding one of the cores. Each of the cores has a shape extending from the first substrate end surface toward the second substrate end surface, a first core end surface located near the first substrate end surface, and a second core end surface located near the second substrate end surface. Each of the first core end surfaces is positioned inside the glass substrate so as to be spaced apart from the first substrate end surface by a certain distance. Similarly, each of the second core end surfaces is positioned inside the glass substrate so as to be spaced apart from the second substrate end surface by a certain distance. Further, each of the first lenses is disposed on the second substrate end surface. Each of the second lenses is disposed on the first substrate end surface. In this manner, by disposing each of the second lenses on the first substrate end surface, the optical connection component of the present disclosure enables optical coupling with an optical connector having a lens structure of a magnifying optical system. In addition, it is possible to relax tolerance of relative positional deviation at the time of coupling. As a result, a simple optical coupling structure can be achieved between the optical connection component of the present disclosure and the external device.

(14) In the above (1), the first lens may be disposed on a third substrate end surface included in the surface of the glass substrate, the third substrate end surface being located between the first substrate end surface and the second substrate end surface, for example, on a bottom surface of the glass substrate. At this time, the second substrate end surface is configured to function as a reflective surface. In order to make the second substrate end surface function as the reflective surface, it is conceivable to incline the second substrate end surface with respect to the first substrate end surface so that light from the second core end surface or the first lens is totally reflected at the second substrate end surface, to provide a reflective film on the second substrate end surface, or to combine these. Each of the cores has a shape extending from the first substrate end surface toward the second substrate end surface, a first core end surface located near the first substrate end surface, and a second core end surface located near the second substrate end surface. Each of the first core end surfaces is positioned on the first substrate end surface. Each of the second core end surfaces is positioned inside the glass substrate so as to be spaced apart from the second substrate end surface by a certain distance. The second substrate end surface is configured to function as a reflective surface, and each of the first lenses is disposed on a third substrate end surface included in the surface of the glass substrate, the third substrate end surface being located between the first substrate end surface and the second substrate end surface, in a state in which each of the first lenses is optically coupled to a corresponding one of the cores via the second substrate end surface. With such a configuration, by appropriately designing a lens and a distance from the first lens to the terminal end position of the core which is an optical waveguide in the glass substrate, a beam having a desired beam quality such as a beam diameter, a beam divergence angle, and a focusing position can be obtained.

(15) In the above (1), the number of the cores may be three or more, and the first lens may be disposed on a third substrate end surface included in the surface of the glass substrate, the third substrate end surface being located between the first substrate end surface and the second substrate end surface, for example, on a bottom surface of the glass substrate, similarly to the above (14). At this time, the second substrate end surface is configured to function as a reflective surface. Each of the cores has a shape extending from the first substrate end surface toward the second substrate end surface, a first core end surface located near the first substrate end surface, and a second core end surface located near the second substrate end surface. The second substrate end surface is configured to function as a reflective surface and inclined with respect to the first substrate end surface. The second core end surfaces are arranged two-dimensionally inside the glass substrate so as to be spaced apart from the second substrate end surface by a certain distance when the second core end surfaces are viewed from the second substrate end surface toward the first substrate end surface and such that optical path lengths from the second core end surfaces to the respective first lenses, via the second substrate end surface, coincide with each other. In this configuration, the “optical path length” is defined on the optical axis of light propagating between the second core end surface and the first lens via the second substrate end surface. Further, each of the first lenses is disposed on a third substrate end surface included in the surface of the glass substrate, the third substrate end surface being located between the first substrate end surface and the second substrate end surface, in a state in which each of the first lenses is optically coupled to a corresponding one of the cores via the second substrate end surface. Also in this configuration, by appropriately designing a lens and a distance from the first lens to the terminal end position of the core which is the optical waveguide in the glass substrate, a beam having a desired beam quality such as a beam diameter, a beam divergence angle, and a focusing position can be obtained.

Each of the aspects listed in the “Description of Embodiments of Present Disclosure” section above is applicable to each of the remaining aspects or to all combinations of these remaining aspects.

### Details of Embodiments of Present Disclosure

Hereinafter, a specific structure of an optical connection component of the present disclosure will be described in detail with reference to the accompanying drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description thereof will be omitted.

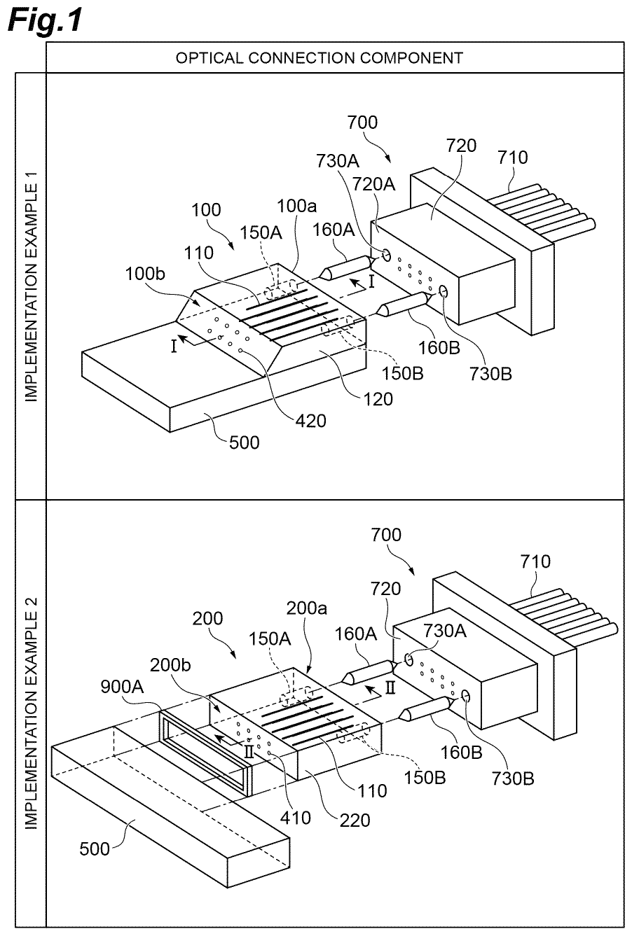

FIG. 1 is a diagram for explaining various implementation examples of the optical connection component of the present disclosure (in FIG. 1, referred to as “Optical Connection Component”). An upper part of FIG. 1 (referred to as “Implementation Example 1” in FIG. 1) shows an implementation example of an optical connection component 100 of the present disclosure in which one of optical input/output end faces located at both ends is inclined. A lower part of FIG. 1 (referred to as “Implementation Example 2” in FIG. 1) shows an implementation example of an optical connection component 200 of the present disclosure in which optical input/output end faces located at both ends are arranged in parallel.

In the Implementation Example 1 shown in the upper part of FIG. 1, the optical connection component 100 of the present disclosure is fixed to an upper surface of an optical IC substrate 500 where optical input/output positions are arranged, and the optical IC substrate 500 and an optical connector 700 are optically connected. The optical IC substrate 500 is an example of a Si-based external device, and the optical connector is an example of a resin external device. The optical connection component 100 includes a glass substrate 120 in which one or more cores 110 are formed inside, and one or more lenses 420. The glass substrate 120 has a first substrate end surface 100a facing the optical connector 700 and a second substrate end surface 100b located opposite to the first substrate end surface 100a, and the cores 110 are arranged between the first substrate end surface 100a and the second substrate end surface 100b. The lenses 420 are provided in one-to-one correspondence with the cores 110, and are arranged on a surface of the glass substrate 120 in a state in which each of the lenses 420 is optically coupled to a corresponding one of the cores 110. The optically coupled state means that the coupling efficiency is 80% or more.

The glass substrate 120 is made of a glass material transparent to a wavelength of light propagating through each of the cores 110, for example, light in a communication wavelength band of 1.310 μm to 1.565 μm corresponding to S band to C band. The transparent means that the material with a thickness of 1 mm has a transmissivity of 95% or more. The second substrate end surface 100b of the glass substrate 120 is inclined with respect to the first substrate end surface 100a, and the lenses 420 are arranged on the second substrate end surface 100b. Each of the lenses 420 functions as a reflection type lens that changes the traveling direction of light from the core 110 so as to optically couple the core 110 and the optical IC substrate. Thus, an inclination angle of the second substrate end surface 100b is set so that a total reflection condition is satisfied on an exposed convex surface of the lens 420. Further, the first substrate end surface 100a of the glass substrate 120 is provided with guide holes 150A and 150B into which first ends of guide pins 160A and 160B are inserted, respectively. The guide holes 150a and 150B function as a positioning structure configured to determine relative positions of the cores 110 with respect to the optical connector 700 facing the first substrate end surface 100a and having a structure configured to enable the optical connector 700 to be optically coupled to the cores 110.

The optical connector 700 includes a fiber tape 710 including a plurality of optical fibers and a ferrule 720 attached to an end portion of the fiber tape 710. A plurality of openings for exposing end faces of the optical fibers included in the fiber tape 710 are provided on a ferrule end surface 720A of the ferrule 720 facing the first substrate end surface 100a. Further, guide holes 730A and 730B into which second ends of the guide pins 160A and 160B are respectively inserted are provided on the ferrule end surface 720A. Thus, the guide pins 160A and 160B are respectively inserted into the guide holes 150a and 150B of the glass substrate 120 and the guide holes 730A and 730B of the ferrule 720, so that the relative positions of the cores 110 are fixed with respect to the optical connector 700.

In the Implementation Example 2 shown in the lower part of FIG. 1, the optical connection component 200 of the present disclosure is fixed to a side surface of the optical IC substrate 500 where the optical input/output positions are arranged, and the optical IC substrate 500 and the optical connector 700 are optically connected. The optical connection component 200 includes a glass substrate 220 in which one or more cores 110 are formed inside, and one or more lenses 410, similarly to the optical connection component 100. The glass substrate 220 has a first substrate end surface 200a facing the optical connector 700 and a second substrate end surface 200b located opposite to the first substrate end surface 200a. The cores 110 are arranged between the first substrate end surface 200a and the second substrate end surface 200b. The lenses 410 are provided in one-to-one correspondence with the cores 110, and are arranged on a surface of the glass substrate 220 in a state in which each of lenses 410 is optically coupled to a corresponding one of the cores 110. The optically coupled state means that the coupling efficiency is 80% or more.

The glass substrate 220 is made of a glass material transparent to the wavelength of light propagating through each of the cores 110, for example, light in a communication wavelength band of 1.310 μm to 1.565 μm. The transparent means that the material with a thickness of 1 mm has a transmissivity of 95% or more. Further, the first substrate end surface 200a and the second substrate end surface 200b of the glass substrate 220 are arranged in parallel, and the lens 410 are arranged on the second substrate end surface 200b. Each of the lenses 410 functions as a transmission type lens that guides light from the core 110 to the optical IC substrate 500 so as to optically couple the core 110 and the optical IC substrate 500. Thus, a spacer member 900A for maintaining a space for accommodating the lenses 410 is disposed between the optical IC substrate 500 and the second substrate end surface 200b. Further, the first substrate end surface 200a of the glass substrate 220 is provided with the guide holes 150A and 150B into which the first ends of the guide pins 160A and 160B are inserted, respectively. The guide holes 150a and 150B are opened in the first substrate end surface 200a and function as a positioning structure configured to determine relative positions of the cores 110 with respect to the optical connector 700 having a structure configured to enable the optical connector 700 to be optically coupled to the cores 110.

Specifically, by applying the glass substrate to the optical connection components 100 and 200 of the present disclosure and modifications described below, when the optical connection component is directly mounted on a Si-based external device such as an optical IC substrate manufactured by the SiPh technology, a difference in thermal expansion coefficient between the external device and a portion directly contacting the external device can be reduced. For example, a thermal expansion coefficient of synthetic quartz is about 0.5×10⁻⁶/° C., a thermal expansion coefficient of borofloat glass is about 3×10⁻⁶/° C.), and a thermal expansion coefficient of aluminosilicate glass is about 3.5×10⁻⁶/° C. By using these glass materials as the material of the glass substrate, the thermal expansion with Si is sufficiently reduced, and optical coupling loss is effectively reduced. Further, a resin lens is suitable for the lens applied to the optical connection component of the present disclosure. Since the resin lens is easily manufactured by a three-dimensional shaping technique as compared with a glass lens, a reduction in manufacturing cost and an increase in production amount can be expected. Further, the resin lens may have heat resistance. The resin lens having heat resistance to 260 degrees Celsius can also be used in a reflow process.

In addition, in the optical connection component of the present disclosure, the glass substrate incorporating the core serving as an optical waveguide and the lens can be separately manufactured. In this case, since the position of the core end face and the position of the lens can be measured separately, it is easy to obtain a submicron accuracy as a relative position error between the lens and the core, which is required in single mode propagation. In addition, it is easy to customize optical waveguide structures represented by core shapes and lenses having different configurations, and the optical connection component of the present disclosure can easily meet various specification requirements.

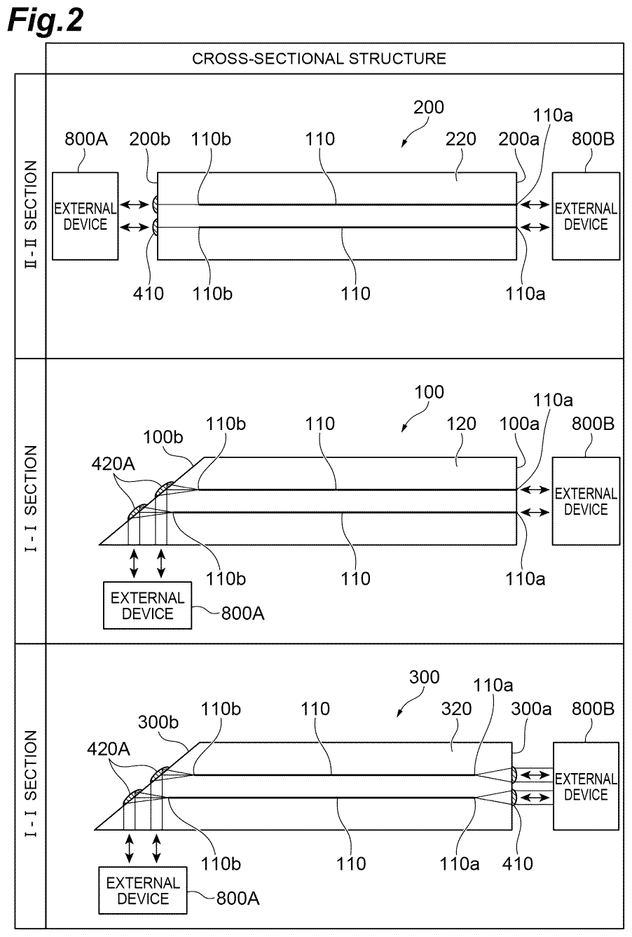

FIG. 2 is a diagram showing examples of typical cross-sectional structures of the optical connection component of the present disclosure (in FIG. 2, referred to as “Cross-sectional Structure”). An upper part of FIG. 2 (referred to as “II-II Section” in FIG. 2) shows a cross-sectional structure of the optical connection component 200 taken along the line II-II shown in the lower part of FIG. 1. A middle part of FIG. 2 (referred to as “I-I Section” in FIG. 2) shows a cross-sectional structure of the optical connection component 100 taken along the line I-I shown in the upper part of FIG. 1. A lower part of FIG. 2 (referred to as “I-I Section” in FIG. 2) shows a cross-sectional structure of another optical connection component 300 corresponding to the section taken along the line I-I shown in the upper part of FIG. 1.

The optical connection component 200 shown in the upper part of FIG. 2 includes the glass substrate 220 in which a plurality of cores 110 are formed inside, and the transmission type lenses 410. The glass substrate 220 has the first substrate end surface 200a facing an external device 800B made of resin such as the optical connector 700, and the second substrate end surface 200b arranged in parallel to the first substrate end surface 200a. The core 110 extends from the first substrate end surface 200a toward the second substrate end surface 200b. The core 110 has a first core end surface 110a located near the first substrate end surface 200a and a second core end surface 110b located near the second substrate end surface 200b. The bottom surface of the glass substrate 220 faces a side surface of a Si-based external device 800A such as the optical IC substrate 500.

In the example of the optical connection component 200, the number of cores 110 is three or more, and the first core end surfaces 110a of the cores 110 are arranged two-dimensionally on the first substrate end surface 200a. The second core end surface 110b is positioned inside the glass substrate 220 so as to be spaced apart from the second substrate end surface 200b by a certain distance. Further, the second core end surfaces 110b are arranged two-dimensionally when the second core end surfaces 110b are viewed from the second substrate end surface 200b toward the first substrate end surface 200a. The lenses 410 are arranged on the second substrate end surface 200b in one-to-one correspondence with the cores 110, and collimate lights output from the second core end surfaces 110b or focus collimated lights from the external device 800A on the second core end surfaces 110b. The collimated light transmitted through the lens 410 is supplied to the optical input/output position located on an upper surface of the Si-based external device 800A. On the other hand, the collimated light from the external device 800A is reflected by lens 420A, and the reflected light is focused on the second core end surface 110b. In the example of the optical connection component 200, distances from the first substrate end surface 200a to the second core end surfaces 110b coincide with each other among the cores 110, and optical path lengths from the second core end surfaces 110b to the second substrate end surface 200b also coincide with each other. In this manner, the first core end surface 110a extends to the first substrate end surface 200a, and thus the core 110 inside the glass substrate 220 and the external device 800B made of resin can be optically coupled. Further, the second core end surface 110b is terminated inside the glass substrate 220, and the lens 410 is disposed at a position where light from the terminated second core end surface 110b reaches. In this manner, by appropriately designing a lens and a distance from the lens 410 to the terminal end position of the core 110 inside the glass substrate 220, a beam having a desired beam quality such as a beam diameter, a beam divergence angle, and a focusing position can be obtained.

The optical connection component 100 shown in the middle part of FIG. 2 includes the glass substrate 120 in which the plurality of cores 110 are formed inside, and the reflection type lenses 420A. The glass substrate 120 has the first substrate end surface 100a facing the external device 800B made of resin and the second substrate end surface 100b inclined with respect to the first substrate end surface 100a. The core 110 extends from the first substrate end surface 100a toward the second substrate end surface 100b. The core 110 has the first core end surface 110a located near the first substrate end surface 100a and the second core end surface 110b located near the second substrate end surface 100b. The bottom surface of the glass substrate 120 faces the upper surface of the Si-based external device 800A.

In the example of the optical connection component 100, the number of cores 110 is three or more. The first core end surfaces 110a of the cores 110 are arranged two-dimensionally on the first substrate end surface 100a. The second core end surface 110b is positioned inside the glass substrate 120 as to be spaced apart from the second substrate end surface 100b by a certain distance. Further, the second core end surfaces 110b are arranged two-dimensionally when the second core end surfaces 110b are viewed from the second substrate end surface 100b toward the first substrate end surface 100a. The lenses 420A are arranged on the second substrate end surface 100b in one-to-one correspondence with the cores 110, and collimate lights output from the second core end surfaces 110b or focus collimated lights from the external device 800A on the second core end surfaces 110b. The inclination angle of the second substrate end surface 100b is set to an angle at which light reaching the lens 420A from the core 110 is totally reflected. The traveling direction of the light is bent, for example, at a right angle by the reflection. The collimated light reflected by the lens 420A is supplied to the Si-based external device 800A. On the other hand, the collimated light from the external device 800A is reflected by the lens 420A, and the reflected light is focused on the second core end surface 110b. In the example of the optical connection component 100, among the cores 110, distances from the first substrate end surface 100a to the second core end surfaces 110b are different, but optical path lengths from the second core end surfaces 110b to the second substrate end surface 100b coincide with each other.

When the glass substrate 120 in which the cores 110 are formed by a short-pulse laser such as a femtosecond laser is used, the pitch between the cores and the terminal end positions of the cores 110 can be flexibly changed. Thus, the terminal end positions of the cores 110 arranged two-dimensionally can be flexibly changed for each row. In addition, when the direction in which light travels is bent by 90 degrees, the distances from the terminal end positions of the cores 110 arranged two-dimensionally to the respective lens 420A can be kept constant, and the beam quality such as the beam diameter, the beam divergence angle, and the focusing position can be standardized among the cores 110. Further, by utilizing such technical features, it is possible to form collimated light having any beam diameter while changing the optical paths from the cores 110 arranged two-dimensionally to the perpendicular direction. Moreover, for some of the cores 110, it is also possible to change the beam diameter and the focusing position suitable for the coupling target by changing the distance from the terminal end position of the core 110 to the lens 420A.

The optical connection component 300 shown in the lower part of FIG. 2 includes a glass substrate 320 in which the plurality of cores 110 are formed inside, and two types of lenses 410 and 420A. The lens 410 is a transmission type collimator lens, and 420A is a reflection type collimator lens. The glass substrate 320 has a first substrate end surface 300a facing the external device 800B made of resin and a second substrate end surface 300b inclined with respect to the first substrate end surface 300a. The core 110 extends from the first substrate end surface 300a toward the second substrate end surface 300b. The core 110 has the first core end surface 110a located near the first substrate end surface 300a and the second core end surface 110b located near the second substrate end surface 300b. The bottom surface of the glass substrate 320 faces the upper surface of the Si-based external device 800A.

In the example of the optical connection component 300, the number of cores 110 is three or more. The first core end surface 110a of the core 110 is positioned inside the glass substrate 320 so as to be spaced apart from the first substrate end surface 300a by a certain distance. The second core end surface 110b is also positioned inside the glass substrate 320 so as to be spaced apart from the second substrate end surface 300b by a certain distance. Further, the first core end surfaces 110a are arranged two-dimensionally when the first core end surfaces 110a are viewed from the first substrate end surface 300a toward the second substrate end surface 300b. The second core end surfaces 110b are also arranged two-dimensionally when the second core end surfaces 110b are viewed from the second substrate end surface 300b toward the first substrate end surface 300a.

The lenses 410 are arranged on the first substrate end surface 300a in one-to-one correspondence with the cores 110. The lenses 410 collimate lights from the resin external device 800B or focus collimated lights from the resin external device 800B on the first core end surfaces 110a. The collimated light transmitted through the lens 410 is guided to the first core end surface 110a of the corresponding one of the cores 110. On the other hand, the lenses 420A are arranged on the second substrate end surface 300b in one-to-one correspondence with the cores 110. The lenses 420A collimate lights output from the second core end surfaces 110b or focus the collimated lights from the external device 800A on the second core end surfaces 110b. An inclination angle of the second substrate end surface 300b is set to an angle at which light reaching the lens 420A from the core 110 is totally reflected. The traveling direction of the light is bent, for example, at a right angle by the reflection. The collimated light reflected by the lens 420A is supplied to the Si-based external device 800A. On the other hand, the collimated light from the Si-based external device 800A is reflected by the lens 420A, and the reflected light is focused on the second core end surface 110b. In the example of the optical connection component 300, among the cores 110, the optical path lengths from the first substrate end surface 300a to the first core end surfaces 110a coincide with each other, and the optical path lengths from the second core end surfaces 110b to the second substrate end surface 300b also coincide with each other. However, in the example of the optical connection component 300, distances from the first substrate end surface 300a to the second core end surfaces 110b are different among the cores 110.

As described above, the optical connection component 300 can be optically coupled to an optical connector or the like having a lens structure of a magnifying optical system by arranging the lens 410 on the first substrate end surface 300a optically coupled to the external device made of resin. In addition, it is possible to relax tolerance of relative positional deviation at the time of optical coupling. That is, a simple optical coupling structure can be achieved between the optical connection component 300 and the external device 800B made of resin.

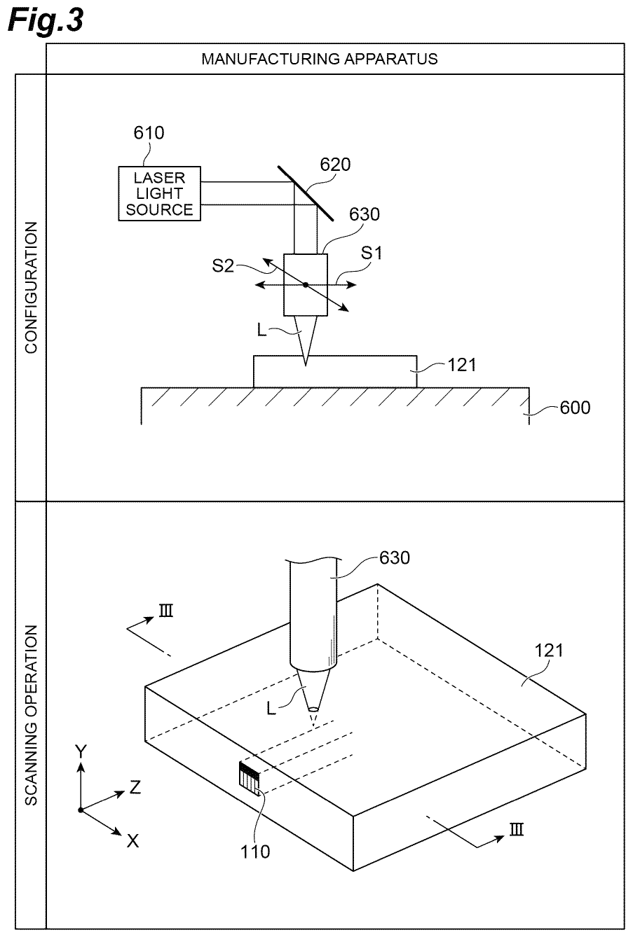

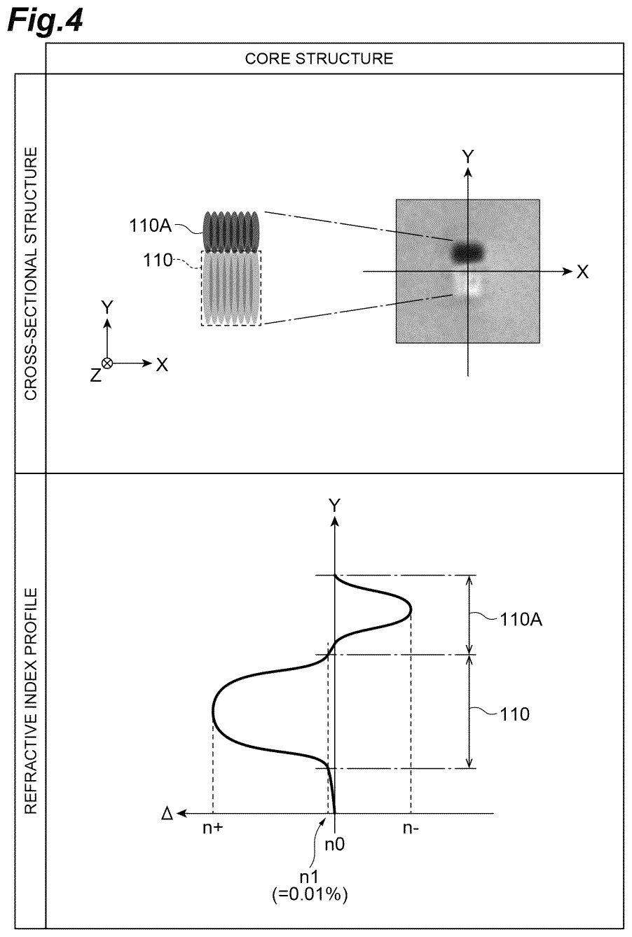

FIG. 3 is a diagram for explaining a manufacturing apparatus and a scanning operation for manufacturing the optical connection component of the present disclosure (in FIG. 3, referred to as “Manufacturing Apparatus”). An upper part of FIG. 3 (in FIG. 3, referred to as “Configuration”) shows a configuration of an apparatus for manufacturing the optical connection component of the present disclosure. A lower part of FIG. 3 (in FIG. 3, referred to as “Scanning Operation”) shows a scanning operation for forming a core inside the glass substrate. FIG. 4 is a diagram for explaining a cross-sectional structure (in FIG. 4, referred to as “Core Structure”) around the core in the optical connection component obtained by the manufacturing apparatus shown in FIG. 3. An upper part of FIG. 4 (in FIG. 4, referred to as “Cross-sectional Structure”) shows a cross-sectional view of the core taken along the line III-III shown in the lower part of FIG. 3. A lower part of FIG. 4 (in FIG. 4, referred to as “Refractive Index Profile”) shows a refractive index profile of the core and its periphery along a Y-axis direction.

The manufacturing apparatus shown in the upper part of FIG. 3 includes a stage 600 on which a glass substrate 121 in which cores as optical waveguides are formed is placed, a laser light source 610 for outputting a short-pulse laser beam L such as femtosecond laser light, a reflective mirror 620 for changing a traveling direction of the short-pulse laser beam L, and a focusing optical system 630 for focusing the short-pulse laser beam L from the reflective mirror 620 into the inside of the glass substrate 121. The focusing optical system 630 is movable in directions indicated by arrows S1 and S2 with respect to the stage 600.

In an actual manufacturing process, as described in Non-patent literature 1, the glass substrate 121 is irradiated with pulsed light of 150 fs at a wavelength of 775 nm and a repetition rate of 1 kHz. As shown in the lower part of FIG. 3, the irradiation operation is performed by repeating the scanning operation along a Z-axis direction a plurality of times while shifting the scanning operation in an X-axis direction, thereby forming the core 110 serving as an optical waveguide inside the glass substrate 121.

The upper part of FIG. 4 shows a schematic diagram and a photograph of the cross-sectional structure of the core 110 formed by the scanning operation shown in the lower part of FIG. 3. As shown in the lower part of FIG. 4, a modified region 110A having a lower refractive index than a refractive index of an unirradiated portion of the glass substrate 121, which is not irradiated with the short-pulse laser beam L, is formed at a focal point of the short-pulse laser beam L, and the core 110, serving as an optical waveguide, is formed under the modified region 110A. In this specification, the core 110 is defined as a region where a relative refractive index difference A is 0.01% or more with respect to the refractive index of the unirradiated portion of the glass substrate 121, as shown in the lower part of FIG. 4. In the lower part of FIG. 4, n0 indicates a relative refractive index difference of 0% as a reference, n1 indicates a relative refractive index difference of 0.01%, n+ indicates a maximum relative refractive index difference having a positive value, and n− indicates a minimum relative refractive index difference having a negative value.

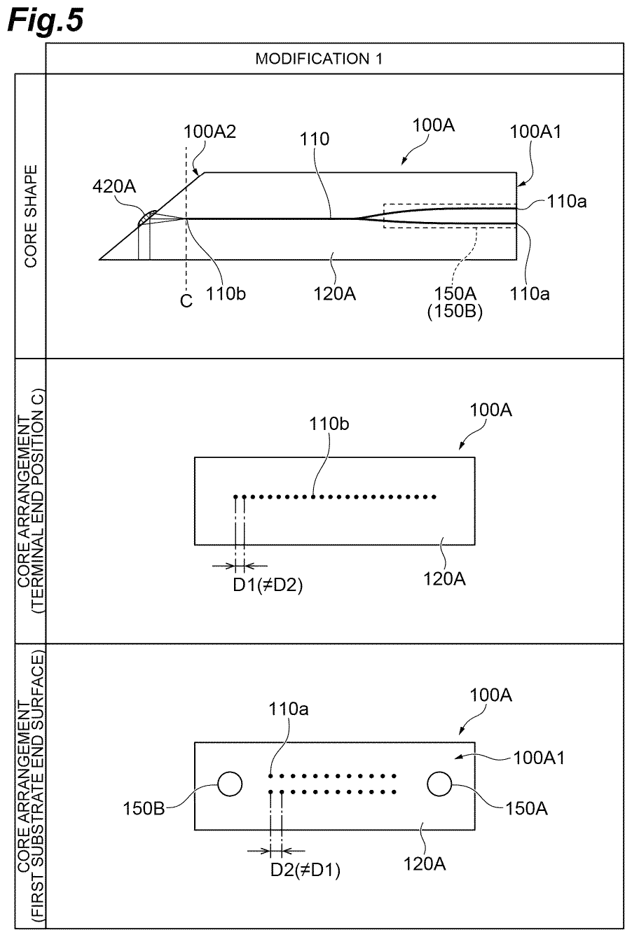

FIG. 5 is a diagram showing a first modification of the optical connection component of the present disclosure and a core arrangement thereof (in FIG. 5, referred to as “Modification 1”). An upper part of FIG. 5 (in FIG. 5, referred to as “Core Shape”) shows cores viewed from a side of the optical connection component. A middle part of FIG. 5 (in FIG. 5, referred to as “Core Arrangement (Terminal End Position C)”) shows the core arrangement at the terminal end position C shown in the upper part of FIG. 5. A lower part of FIG. 5 (in FIG. 5, referred to as “Core Arrangement (First Substrate End Surface)”) shows the core arrangement at the first substrate end surface.

An optical connection component 100A according to the first modification shown in the upper part of FIG. 5 includes a glass substrate 120A in which the plurality of cores 110 are formed inside and the reflection type lenses 420A. The glass substrate 120A has a first substrate end surface 100A1 facing the external device 800B made of resin such as the optical connector 700, and a second substrate end surface 100A2 inclined with respect to the first substrate end surface 100A1. The core 110 extends from the first substrate end surface 100A1 toward the second substrate end surface 100A2. The core 110 has the first core end surface 110a located near the first substrate end surface 100A1 and the second core end surface 110b located near the second substrate end surface 100A2. In this optical connection component 100A as well, a bottom surface of the glass substrate 120A faces the upper surface of the Si-based external device 800A such as the optical IC substrate 500.

In the example of the optical connection component 100A, the number of cores 110 is three or more. The first core end surfaces 110a of the cores 110 are arranged two-dimensionally on the first substrate end surface 100A1 as shown in the lower part of FIG. 5. The second core end surfaces 110b are positioned inside the glass substrate 120A so as to be spaced apart from the second substrate end surface 100A2 by a certain distance. Specifically, the positions of the second core end surfaces 110b of the cores 110 are the terminal end position C indicated by the dashed line in the upper part of FIG. 5. Further, as shown in the middle part of FIG. 5, the second core end surfaces 110b are arranged one-dimensionally when the second core end surfaces 110b are viewed from the second substrate end surface 100A2 toward the first substrate end surface 100A1. The lenses 420A are arranged on the second substrate end surface 100A2 in one-to-one correspondence with the cores 110, and collimate lights output from the second core end surfaces 110b of the cores 110 or focus collimated lights from the external device 800A on the second core end surfaces 110b. An inclination angle of the second substrate end surface 100A2 is set to an angle at which light reaching the lens 420A from the core 110 is totally reflected. The traveling direction of the light is bent, for example, at a right angle by the reflection. The collimated light reflected by the lens 420A is supplied to the external device 800A. On the other hand, the collimated light from the external device 800A is reflected by the lens 420A, and the reflected light is focused on the second core end surface 110b.

In the example of the optical connection component 100A, among the cores 110, distances from the first substrate end surface 100A1 to the second core end surfaces 110b coincide with each other, and optical path lengths from the second core end surfaces 110b to the respective lenses 420A on the second substrate end surface 110A2 also coincide with each other. Further, in the example of the optical connection component 100A, as shown in the middle and lower parts of FIG. 5, a core pitch at the terminal end position C of the cores 110, that is, a center-to-center distance between each adjacent pair of the second core end surfaces 110b is given by D1. Further, a core pitch at the first substrate end surface 100A1 of the cores 110, that is, a center-to-center distance between each adjacent pair of the first core end surfaces 110a is given by D2. In the optical connection component 100A, D1 and D2 are different.

As described above, by using the optical connection component 100A, the core pitch at the first substrate end surface 100A1 and the core pitch at the terminal end position C can be flexibly converted. That is, the pitch conversion of the optical input/output positions and the arrangement conversion from the one-dimensional arrangement to the two-dimensional arrangement can be easily achieved. In this manner, by using the optical connection component 100A, optical coupling from the optical connector 700 in which optical fibers are arranged two-dimensionally by overlapping a plurality of fiber tapes 710 to a SiPh chip such as the optical IC substrate 500 in which optical input/output positions are arranged one-dimensionally can also be achieved.

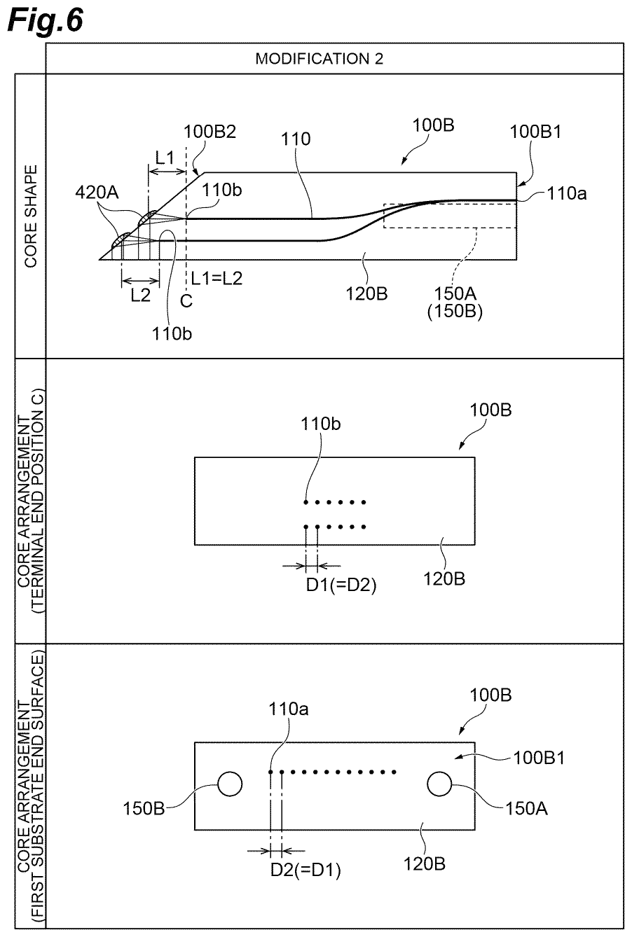

FIG. 6 is a diagram showing a second modification of the optical connection component of the present disclosure and a core arrangement thereof (in FIG. 6, referred to as “Modification 2”). An upper part of FIG. 6 (in FIG. 6, referred to as “Core Shape”) shows cores viewed from the side of the optical connection component. A middle part of FIG. 6 (in FIG. 6, referred to as “Core Arrangement (Terminal End Position C)”) shows the core arrangement at the terminal end position C shown in the upper part of FIG. 6. A lower part of FIG. 6 (in FIG. 6, referred to as “Core Arrangement (First Substrate End Surface)”) shows the core arrangement at the first substrate end surface.

An optical connection component 100B according to the second modification shown in the upper part of FIG. 6 includes a glass substrate 120B in which the plurality of cores 110 are formed inside and the reflection type lenses 420A. The glass substrate 120B has a first substrate end surface 100B1 facing the external device 800B made of resin such as the optical connector 700, and a second substrate end surface 100B2 inclined with respect to the first substrate end surface 100B1. The core 110 extends from the first substrate end surface 100B1 toward the second substrate end surface 100B2. The core 110 has the first core end surface 110a located near the first substrate end surface 100B1 and the second core end surface 110b located near the second substrate end surface 100B2. In this optical connection component 100B, a bottom surface of the glass substrate 120B faces the upper surface of the Si-based external device 800A such as the optical IC substrate 500.

In the example of the optical connection component 100B, the number of cores 110 is three or more. The first core end surfaces 110a of the cores 110 are arranged one-dimensionally on the first substrate end surface 100B1 as shown in the lower part of FIG. 6. The second core end surfaces 110b are positioned inside the glass substrate 120B so as to be spaced apart from the second substrate end surface 100B2 by a certain distance. In the upper part of FIG. 6, the terminal end position C is indicated by a dashed line at the position of the second core end surface 110b closest to the first substrate end surface 100B1. As shown in the middle part of FIG. 6, the second core end surfaces 110b are arranged two-dimensionally when the second core end surfaces 110b are viewed from the second substrate end surface 100B2 toward the first substrate end surface 100B1. The lenses 420A are arranged on the second substrate end surface 100B2 in one-to-one correspondence with the cores 110, and collimate lights output from the second core end surfaces 110b of the cores 110 or focus collimated lights from the external device 800A on the second core end surfaces 110b. An inclination angle of the second substrate end surface 100B2 is set to an angle at which light reaching the lens 420A from the core 110 is totally reflected. The traveling direction of the light is bent, for example, at a right angle by the reflection. The collimated light reflected by the lens 420A is supplied to the external device 800A. On the other hand, the collimated light from the external device 800A is reflected by the lens 420A, and the reflected light is focused on the second core end surface 110b.

In the example of the optical connection component 100B, distances from the first substrate end surface 100B1 to the second core end surfaces 110b are different among the cores 110. However, an optical path length L1 from the second core end surface 110b closest to the first substrate end surface 100B1 to the lens 420A on the second substrate end surface 100B2 coincides with an optical path length L2 from the second core end surface 110b farthest from the first substrate end surface 100B1 to the lens 420A on the second substrate end surface 100B2. Further, in the example of the optical connection component 100B, as shown in the middle and lower parts of FIG. 6, the core pitch D1 at the terminal end position C of the cores 110 coincides with the core pitch D2 at the first substrate end surface 100B1. That is, the optical connection component 100B has a configuration in which the optical input/output positions of the resin external device 800B such as the optical connector 700 are arranged one-dimensionally, and the lenses 420A on the second substrate end surface 100B2 are arranged two-dimensionally. Thus, even when the optical input/output positions of the external device 800A are arranged two-dimensionally, the optical input/output positions of both the external device 800B and the external device 800A can be matched by using the optical connection component 100B.

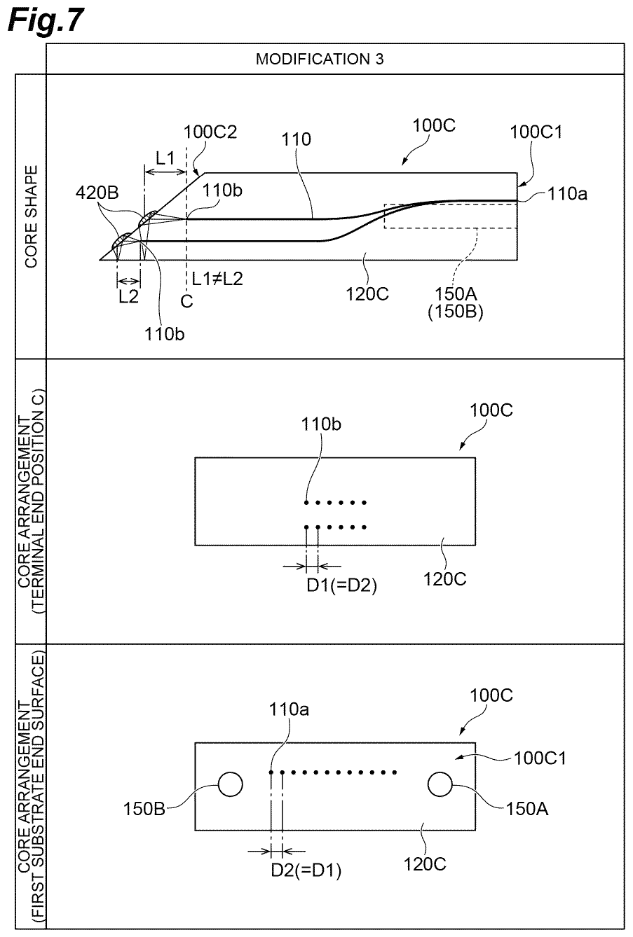

FIG. 7 is a diagram showing a third modification of the optical connection component of the present disclosure and a core arrangement thereof (in FIG. 7, referred to as “Modification 3”). An upper part of FIG. 7 (in FIG. 7, referred to as “Core Shape”) shows cores viewed from the side of the optical connection component. A middle part of FIG. 7 (in FIG. 7, referred to as “Core Arrangement (Terminal End Position C)”) shows the core arrangement at the terminal end position C shown in the upper part of FIG. 7. A lower part of FIG. 7 (in FIG. 7, referred to as “Core Arrangement (First Substrate End Surface)”) shows the core arrangement at the first substrate end surface.

An optical connection component 100C according to the third modification shown in the upper part of FIG. 7 includes a glass substrate 120C in which the plurality of cores 110 are formed inside and two types of reflection type lenses 420B having different focusing positions. The glass substrate 120C has a first substrate end surface 100C1 facing the external device 800B made of resin such as the optical connector 700, and a second substrate end surface 100C2 inclined with respect to the first substrate end surface 100C1. The core 110 extends from the first substrate end surface 100C1 toward the second substrate end surface 100C2. The core 110 has the first core end surface 110a located near the first substrate end surface 100C1 and the second core end surface 110b located near the second substrate end surface 100C2. In this optical connection component 100C, a bottom surface of the glass substrate 120C faces the upper surface of the Si-based external device 800A such as the optical IC substrate 500.

In the example of the optical connection component 100C, the number of cores 110 is three or more. The first core end surfaces 110a of the cores 110 are arranged one-dimensionally on the first substrate end surface 100C1 as shown in the lower part of FIG. 7. The second core end surfaces 110b are positioned inside the glass substrate 120C so as to be spaced apart from the second substrate end surface 100C2 by a certain distance. In the upper part of FIG. 7, the terminal end position C is indicated by a dashed line at the position of the second core end surface 110b closest to the first substrate end surface 100C1. As shown in the middle part of FIG. 7, the second core end surfaces 110b are arranged two-dimensionally when the second core end surfaces 110b are viewed from the second substrate end surface 100C2 toward the first substrate end surface 100C1. The reflection type lenses 420B functioning as focusing lenses are arranged on the second substrate end surface 100C2 in one-to-one correspondence with the cores 110, and focus light output from the second core end surfaces 110b of the cores 110. An inclination angle of the second substrate end surface 100C2 is set to an angle at which light reaching the lens 420B from the core 110 is totally reflected. The traveling direction of the light is bent, for example, at a right angle by the reflection. The light reflected and focused by the lens 420B is supplied to the external device 800A. Conversely, the light from the external device 800A is reflected by the lens 420B and is focused on the second core end surface 110b.

In the example of the optical connection component 100C to which the lenses 420B functioning as reflection type focusing lenses are applied, distances from the first substrate end surface 100C1 to the second core end surfaces 110b are different among the cores 110. Further, the optical path length L1 from the second core end surface 110b closest to the first substrate end surface 100C1 to the lens 420B on the second substrate end surface 100C2 is different from the optical path length L2 from the second core end surface 110b farthest from the first substrate end surface 100C1 to the lens 420B on the second substrate end surface 100C2. Further, in the example of the optical connection component 100C, as shown in the middle and lower parts of FIG. 7, the core pitch D1 at the terminal end position C of the core 110 coincides with the core pitch D2 at the first substrate end surface 100C1. That is, the optical connection component 100C also has a configuration in which the optical input/output positions of the resin external device 800B such as the optical connector 700 are arranged one-dimensionally, and the lenses 420B on the second substrate end surface 100C2 is arranged two-dimensionally, similarly to the case of the modification 2 described above. Thus, even when the optical input/output positions of the external device 800A are arranged two-dimensionally, the optical input/output positions of both the external device 800B and the external device 800A can be matched by using the optical connection component 100C.

Further, according to the optical connection component 100C, it is possible to produce a beam having any beam quality. In addition, when the lens 420B is made of resin, it is easy to design each lens as desired by using 3D molding technique. That is, by using the optical connection component 100C, light having any beam diameter can be formed while changing the optical paths from the cores 110 arranged two-dimensionally to the perpendicular direction. In this case, the distance from the terminal end position C of the core 110 to the respective lens 420B do not need to be the same among the cores 110, and may be appropriately set according to the beam diameter desired to be obtained at the terminal end position C of the core 110. For example, inside the glass substrate 120C, in a configuration in which the distance from the terminal end position C of the core 110 to the respective lens 420B coincides with the distance from the lens 420B to the bottom surface of the glass substrate 120C and each lens 420B has an appropriate focal length, the beam can be focused so that the beam diameter and the mode field of the core 110 which is a waveguide coincide with each other on the bottom surface of the glass substrate 120C.

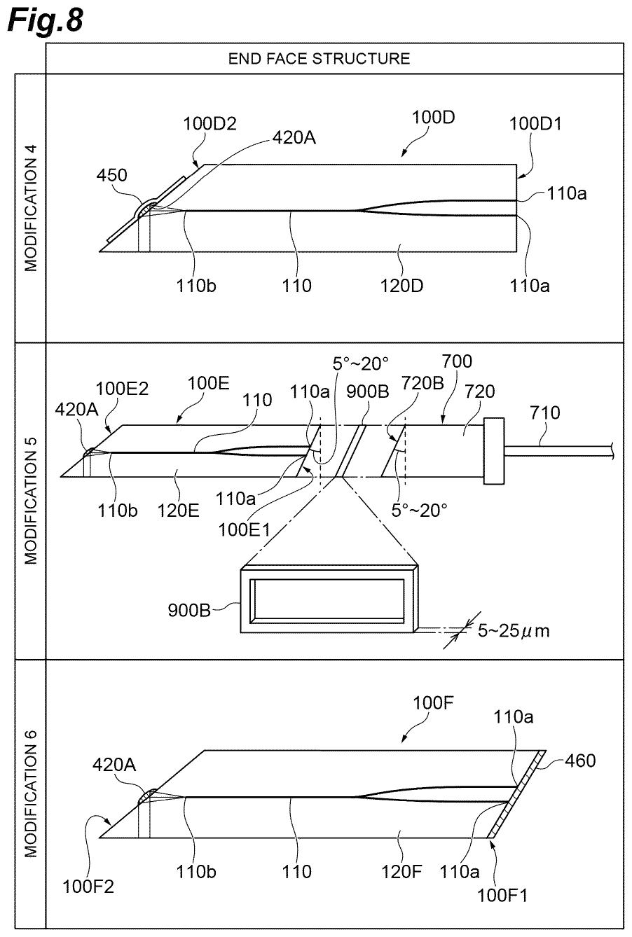

FIG. 8 is a diagram showing a core shape of each of a fourth modification to a sixth modification of the optical connection component of the present disclosure (in FIG. 8, referred to as “End Face Structure”). An upper part of FIG. 8 (in FIG. 8, referred to as “Modification 4”) shows an end face structure of an optical connection component according to the fourth modification. A middle part of FIG. 8 (in FIG. 8, referred to as “Modification 5”) shows an end face structure of an optical connection component according to the fifth modification. A lower part of FIG. 8 (in FIG. 8, referred to as “Modification 6”) shows an end face structure of an optical connection component according to the sixth modification.

An optical connection component 100D according to the fourth modification shown in the upper part of FIG. 8 includes a glass substrate 120D in which the plurality of cores 110 are formed inside, and the reflection type lenses 420A that collimate light from the cores 110. The glass substrate 120D has a first substrate end surface 100D1 facing the external device 800B such as the optical connector 700 and a second substrate end surface 100D2 inclined with respect to the first substrate end surface 100D1. The core 110 extends from the first substrate end surface 100D1 toward the second substrate end surface 100D2. The core 110 has the first core end surface 110a located near the first substrate end surface 100D1 and the second core end surface 110b located near the second substrate end surface 100D2. In this optical connection component 100D, a bottom surface of the glass substrate 120D faces the upper surface of the Si-based external device 800A such as the optical IC substrate 500.

In the example of the optical connection component 100D, the number of cores 110 is three or more. The core shape has the same shape as the first modification shown in FIG. 5. The optical connection component 100D includes a reflective film 450 covering a surface of each of the reflection type lenses 420A functioning as a collimator lens, excluding a surface of each of the reflection type lenses 420A facing a surface of the glass substrate 120D. Even in a configuration in which light is totally reflected at the surface of the lens 420A, the refractive index difference between the inside of the lens and the lens surface may change if a foreign matter adheres to the surface of the lens 420A. When the refractive index difference changes on the lens surface in this manner, reflection characteristics of the lens 420A may change. Thus, the optical connection component 100D is provided with the reflective film 450 made of a metal film or a multilayer film on an exposed surface of the lens 420A, thereby making it possible to reflect light from the second core end surface 110b of the core 110 with high efficiency.

An optical connection component 100E according to the fifth modification shown in the middle part of FIG. 8 includes a glass substrate 120E in which the plurality of cores 110 are formed inside, and the reflection type lenses 420A that collimate light from the cores 110. The glass substrate 120E has a first substrate end surface 100E1 facing the external device 800B such as the optical connector 700 and a second substrate end surface 100E2 inclined with respect to the first substrate end surface 100E1. The core 110 extends from the first substrate end surface 100E1 toward the second substrate end surface 100E2. The core 110 has the first core end surface 110a located near the first substrate end surface 100E1 and the second core end surface 110b located near the second substrate end surface 100E2. In this optical connection component 100E, a bottom surface of the glass substrate 120E faces the upper surface of the Si-based external device 800A such as the optical IC substrate 500.

In the example of the optical connection component 100E, the number of cores 110 is three or more. The core shape has the same shape as the first modification shown in FIG. 5. In the optical connection component 100E, the first substrate end surface 100E1 is inclined in a range of 5 degrees to 20 degrees with respect to a reference plane perpendicular to a central axis of an end portion of each of the cores 110 including the first core end surface 110a. In the middle part of FIG. 8, the reference plane is indicated by a dashed line. When the optical connector 700 is applied as the external device 800B, similarly, a ferrule end surface 720B of the optical connector 700 facing the first substrate end surface 100E1 is also inclined in a range of 5 degrees to 20 degrees with respect to a reference plane indicated by the dashed line. In particular, by inclining the first substrate end surface 100E1 and the ferrule end surface 720B by, for example, about 8 degrees, it is possible to achieve a reflection loss of 40 dB or more or a value close to it while reducing occurrence of an excessive insertion loss. In this case, reflected light is not coupled back to each core 110, and the influence on propagation characteristics is effectively reduced. The reflection loss can be measured by a reflection attenuation meter.

Further, the optical connection component 100E may include a spacer member 900B disposed on the first substrate end surface 100E1 so as to surround the first core end surfaces 110a and configured to maintain a gap of 5 μm to 25 μm between the inclined the first substrate end surface 100E1 and the inclined ferrule end surface 720B. In this case, since a reflection loss of 40 dB or more can be reliably achieved, so that reflected light is not coupled back to each core 110, and the influence on propagation characteristics is further reduced.

An optical connection component 100F according to the sixth modification shown in the lower part of FIG. 8 includes a glass substrate 120F in which the plurality of cores 110 are formed inside, and the reflection type lenses 420A that collimate light from the cores 110. The glass substrate 120F has a first substrate end surface 100F1 facing the external device 800B such as the optical connector 700 shown in FIGS. 1 and 2, and a second substrate end surface 100F2 inclined with respect to the first substrate end surface 100F1. The core 110 extends from the first substrate end surface 100F1 toward the second substrate end surface 100F2. The core 110 has the first core end surface 110a located near the first substrate end surface 100F1 and the second core end surface 110b located near the second substrate end surface 100F2. In this optical connection component 100F, a bottom surface of the glass substrate 120F faces the upper surface of the Si-based external device 800A such as the optical IC substrate 500.

In the example of the optical connection component 100F, the number of cores 110 is three or more. The core shape has the same shape as the first modification shown in FIG. 5. In the optical connection component 100F, the first core end surfaces 110a of the cores 110 positioned on the first substrate end surface 110F1 are covered with an anti-reflection structure 460. In an oblique structure and a gap structure of the optical connection component 100E according to the fifth modification described above, it is difficult to obtain a reflection loss of 55 dB or more. On the other hand, the optical connection component 100F according to the sixth modification can obtain a reflection loss of 55 dB or more by covering the first core end surfaces 110a with the anti-reflection structure 460. As an example of the anti-reflection structure 460, a generally known structure such as AR coat or a moth-eye structure can be applied.

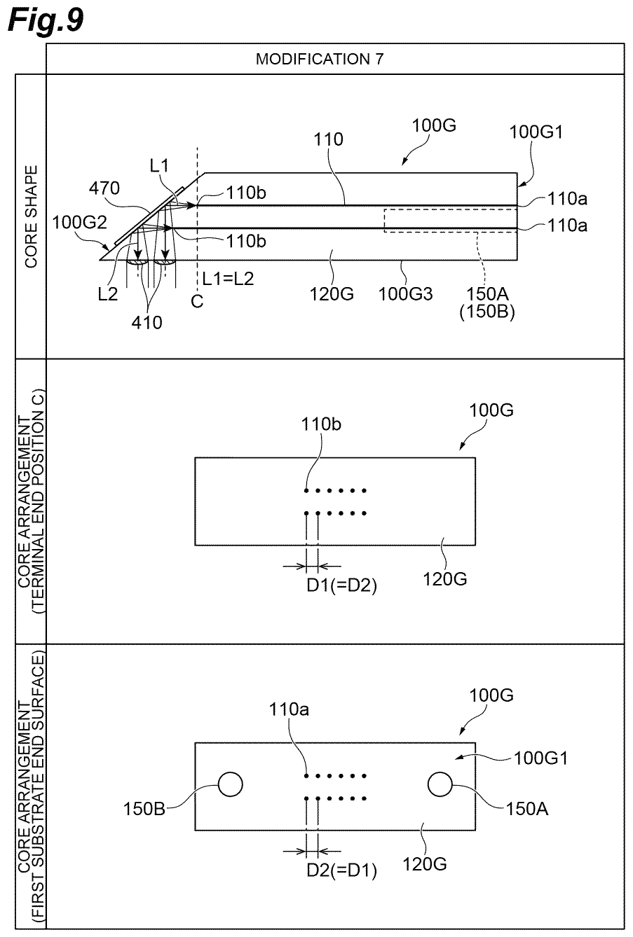

FIG. 9 is a diagram showing a seventh modification of the optical connection component of the present disclosure and a core arrangement thereof (in FIG. 9, referred to as “Modification 7”). An upper part of FIG. 9 (in FIG. 9, referred to as “Core Shape”) shows cores viewed from the side of the optical connection component. A middle part of FIG. 9 (in FIG. 9, referred to as “Core Arrangement (Terminal End Position C)”) shows the core arrangement at the terminal end position C shown in the upper part of FIG. 9. A lower part of FIG. 9 (in FIG. 9, referred to as “Core Arrangement (First Substrate End Surface)”) shows the core arrangement at the first substrate end surface.

An optical connection component 100G according to the seventh modification shown in the upper part of FIG. 9 includes a glass substrate 120G in which the plurality of cores 110 are formed inside, the transmission type lenses 410 that function as collimator lenses, and a reflective film 470 for changing the directions of lights propagating between the cores 110 and the lenses 410 travel. The glass substrate 120G has a first substrate end surface 100G1 facing the external device 800B made of resin such as the optical connector 700 and a second substrate end surface 100G2 inclined with respect to the first substrate end surface 100G1. A bottom surface of the glass substrate 120G corresponds to a third substrate end surface 100G3 located between the first substrate end surface 100G1 and the second substrate end surface 100G2 of the surfaces of the glass substrate 120G, and each of the lenses 410 is disposed on the third substrate end surface 100G3 in a state in which each of the lenses 410 is optically coupled to a corresponding one of the cores 110 via the second substrate end surface 100G2. The second substrate end surface 100G2 is set to have an inclination angle that satisfies a total reflection condition for light from the core 110 and light from the lens 410. Note that, the reflective film 470 that enables more effective reflection on the second substrate end surface 100G2 is provided on the second substrate end surface 100G2. The traveling direction of the light is bent, for example, at a right angle by the reflection. The core 110 extends from the first substrate end surface 100G1 toward the second substrate end surface 100G2. The core 110 has the first core end surface 110a located near the first substrate end surface 100G1 and the second core end surface 110b located near the second substrate end surface 100G2. In this optical connection component 100G, the third substrate end surface 100G3, which is a bottom surface of the glass substrate 120G, faces the upper surface of the Si-based external device 800A such as the optical IC substrate 500 via the lenses 410.

In the example of the optical connection component 100G, the number of cores 110 is three or more. The first core end surfaces 110a of the cores 110 are arranged two-dimensionally on the first substrate end surface 100G1 as shown in the lower part of FIG. 9. The second core end surfaces 110b are positioned inside the glass substrate 120G so as to be spaced apart from the second substrate end surface 100G2 by a certain distance. In the upper part of FIG. 9, the terminal end position C is indicated by a dashed line at the position of the second core end surface 110b closest to the first substrate end surface 100G1. As shown in the middle part of FIG. 9, the second core end surfaces 110b are arranged two-dimensionally when the second core end surfaces 110b are viewed from the second substrate end surface 100G2 toward the first substrate end surface 100G1. The reflective film 470 is disposed on the inclined second substrate end surface 100G2 to improve reflection efficiency. The lenses 410 are arranged on the third substrate end surface 100G3 in one-to-one correspondence with the cores 110 via the second substrate end surface 100G2 configured to function as a reflective surface, and collimate lights output from the second core end surfaces 110b of the cores 110 or focus collimated lights from the external device 800A on the second core end surfaces 110b. The light reflected at the second substrate end surface 100G2 is collimated by the lens 410, and the collimated light is supplied to the external device 800A. On the other hand, the collimated light from the external device 800A is focused by the lens 410 on the second core end surface 110b via the second substrate end surface 100G2.

In the example of the optical connection component 100G, distances from the first substrate end surface 100G1 to the second core end surfaces 110b are different among the cores 110. However, the optical path length LI from the second core end surface 110b closest to the first substrate end surface 100G1 to the corresponding lens 410 via the second substrate end surface 100G2 coincides with the optical path length L2 from the second core end surface 110b farthest from the first substrate end surface 100G1 to the lens 410, via the second substrate end surface 100G2. Further, in the example of the optical connection component 100G, as shown in the middle and lower parts of FIG. 9, the core pitch D1 at the terminal end position C of the core 110 coincides with the core pitch D2 at the first substrate end surface 100G1. That is, the optical connection component 100G has a configuration in which the optical input/output positions of the resin external device 800B such as the optical connector 700 are arranged two-dimensionally, and the lenses 410 on the third substrate end surface 100G3 are also arranged two-dimensionally. Thus, even when the optical input/output positions of the external device 800A are arranged two-dimensionally, the optical input/output positions of both the external device 800B and the external device 800A can be matched by using the optical connection component 100G.

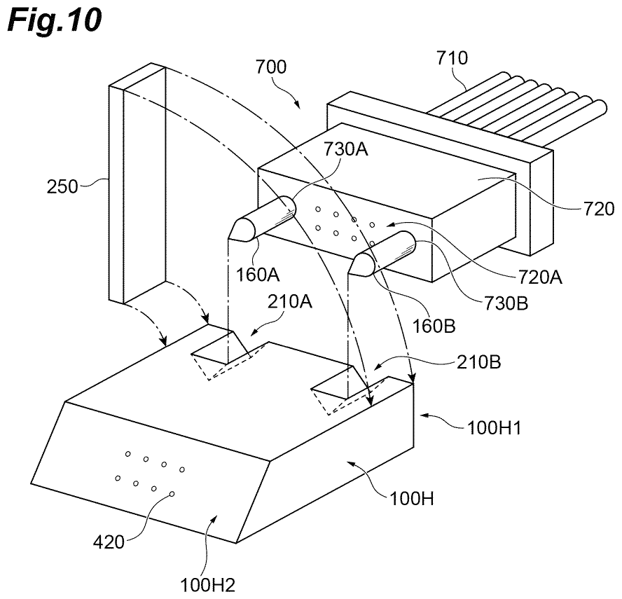

FIG. 10 is a diagram for explaining another implementation example of an optical connection component of the present disclosure. An optical connection component 100H shown in FIG. 10 is different from the optical connection components 100 or 200 shown in the upper part or the lower part of FIG. 1 in a positioning structure for determining relative positions of the cores 110 with respect to the external device 800B such as the optical connector 700 that has a structure capable of being optically coupled to the cores 110.

That is, the optical connection component 100H includes a first substrate end surface 100H1 and an inclined second substrate end surface 100H2, and the reflection type lenses 420 are arranged on the second substrate end surface 100H2. In particular, V-grooves 210A and 210B are provided as a positioning structures near the first substrate end surface 100H1. The guide pins 160A and 160B are inserted into the guide holes 730A and 730B, respectively, provided in the ferrule end surface 720A of the optical connector 700, and the guide pins 160A and 160B are installed in the V-grooves 210A and 210B, respectively. After the installation, the guide pins 160A and 160B are fixed to the V-grooves 210A and 210B, respectively, by an ultraviolet curable resin. In order to stably maintain the fixed state of the guide pins 160A and 160B, the guide pins 160A and 160B may be fixed by an ultraviolet curable resin in a state of being sandwiched between the V-grooves 210A and 210B and a glass cover 250. In this case, a transmissivity of the glass cover 250 with respect to ultraviolet rays of the wavelength of 360 nm to 410 nm is, for example, 40% or more at a thickness of 3 mm. As described above, by providing the V-grooves 210A and 210B in the glass substrate of the optical connection component 100H, the cores provided inside the glass substrate can be passively and optically coupled to the optical connector 700 which is the external device.

### REFERENCE SIGNS LIST

100, 100A to 100H, 200, 300 optical connection component
100a 100A1 to 100H1, 200a, 300a first substrate end surface
100b 100A2 to 100H2, 200b, 300b second substrate end surface
100G3 third substrate end surface
120, 121, 120A to 120G, 220, 320 glass substrate
110 core
110a first core end surface
110b second core end surface
150A, 150B, 730A, 730B guide hole
160A, 160B guide pin
210A, 210B V-groove
250 glass cover
410, 420, 420A, 420B lens
450, 470 reflective film
460 anti-reflection structure
500 optical IC substrate
600 stage
610 laser light source
620 reflective mirror
630 focusing optical system
700 optical connector
710 fiber tape
720 ferrule
720A, 720B ferrule end surface
730A, 730B guide hole
800A, 800B external device
900A, 900B spacer member
L short-pulse laser beam

1. An optical connection component comprising:
a glass substrate having a first substrate end surface and a second substrate end surface located opposite to the first substrate end surface and including one or more cores arranged between the first substrate end surface and the second substrate end surface, the glass substrate being made of a glass material transparent to a wavelength of light propagating through each of the cores; and
one or more first lenses provided in one-to-one correspondence with the cores and arranged on a surface of the glass substrate in a state in which each of the first lenses is optically coupled to a corresponding one of the cores.

2. The optical connection component according to claim 1,
wherein each of the cores has a shape extending from the first substrate end surface toward the second substrate end surface, a first core end surface located near the first substrate end surface, and a second core end surface located near the second substrate end surface,
wherein each of the first core end surfaces is positioned on the first substrate end surface,
wherein each of the second core end surfaces is positioned inside the glass substrate so as to be spaced apart from the second substrate end surface by a certain distance, and
wherein each of the first lenses is disposed on the second substrate end surface.

3. The optical connection component according to claim 1,
wherein the number of the cores is three or more, and each of the cores has a shape extending from the first substrate end surface toward the second substrate end surface, a first core end surface located near the first substrate end surface, and a second core end surface located near the second substrate end surface,
wherein the first core end surfaces are arranged two-dimensionally on the first substrate end surface when the first core end surfaces are viewed from the first substrate end surface toward the second substrate end surface, and
wherein the second core end surfaces are arranged one-dimensionally inside the glass substrate so as to be spaced apart from the second substrate end surface by a certain distance when the second core end surfaces are viewed from the second substrate end surface toward the first substrate end surface.

4. The optical connection component according to claim 1,
wherein the number of the cores is three or more, and each of the cores has a shape extending from the first substrate end surface toward the second substrate end surface, a first core end surface located near the first substrate end surface, and a second core end surface located near the second substrate end surface,
wherein the first core end surfaces are arranged one-dimensionally on the first substrate end surface when the first core end surfaces are viewed from the first substrate end surface toward the second substrate end surface, and
wherein the second core end surfaces are arranged two-dimensionally inside the glass substrate so as to be spaced apart from the second substrate end surface by a certain distance when the second core end surfaces are viewed from the second substrate end surface toward the first substrate end surface.

5. The optical connection component according to claim 1,
wherein the number of the cores is two or more, and each of the cores has a shape extending from the first substrate end surface toward the second substrate end surface, a first core end surface located near the first substrate end surface, and a second core end surface located near the second substrate end surface,
wherein each of the first core end surfaces is positioned on the first substrate end surface,
wherein each of the second core end surfaces is positioned inside the glass substrate so as to be spaced apart from the second substrate end surface by a certain distance, and
wherein a first core pitch that is a center-to-center distance between each adjacent pair of the first core end surfaces differs from a second core pitch that is a center-to-center distance between each adjacent pair of the second core end surfaces.

6. The optical connection component according to claim 1,
wherein the number of the cores is three or more, and each of the cores has a shape extending from the first substrate end surface toward the second substrate end surface, a first core end surface located near the first substrate end surface, and a second core end surface located near the second substrate end surface,
wherein the second substrate end surface is inclined with respect to the first substrate end surface,
wherein the second core end surfaces are arranged two-dimensionally inside the glass substrate so as to be spaced apart from the second substrate end surface by a certain distance when the second core end surfaces are viewed from the second substrate end surface toward the first substrate end surface and such that optical path lengths from the second core end surfaces to the respective first lenses coincide with each other, and
wherein each of the first lenses is disposed on the second substrate end surface, which is inclined.

7. The optical connection component according to claim 1, comprising:
a reflective film covering a surface of each of the first lenses, excluding a surface of each of the first lenses facing the surface of the glass substrate.

8. The optical connection component according to claim 1,
wherein the number of the cores is two or more, and the number of types of the first lenses is two or more.

9. The optical connection component according to claim 1,
wherein the glass substrate has a positioning structure configured to determine relative positions of the cores with respect to an external device having a structure configured to enable the external device to be optically coupled to the cores.

10. The optical connection component according to claim 1,
wherein the first substrate end surface is inclined in a range of 5 degrees to 20 degrees with respect to a plane perpendicular to a central axis of an end portion of each of the cores located near the first substrate end surface.

11. The optical connection component according to claim 10, comprising:
a spacer member disposed between the first substrate end surface and an external device to be optically coupled to the first substrate end surface, the spacer member being configured to maintain a gap of 5 μm to 25 μm between the first substrate end surface and the external device.

12. The optical connection component according to claim 1, comprising:
an anti-reflection structure provided on the first substrate end surface,
wherein each of the cores has a shape extending from the first substrate end surface toward the second substrate end surface, a first core end surface located near the first substrate end surface, and a second core end surface located near the second substrate end surface, and
wherein each of the first core end surfaces is positioned on the first substrate end surface with the anti-reflection structure covering each of the first core end surfaces.

13. The optical connection component according to claim 1, comprising:
one or more second lenses provided in one-to-one correspondence with the cores and arranged on a surface of the glass substrate in a state in which each of the second lenses is optically coupled to a corresponding one of the cores.
wherein each of the cores has a shape extending from the first substrate end surface toward the second substrate end surface, a first core end surface located near the first substrate end surface, and a second core end surface located near the second substrate end surface,
wherein each of the first core end surfaces is positioned inside the glass substrate so as to be spaced apart from the first substrate end surface by a certain distance,
wherein each of the second core end surfaces is positioned inside the glass substrate so as to be spaced apart from the second substrate end surface by a certain distance,
wherein each of the first lenses is disposed on the second substrate end surface, and
wherein each of the second lenses is disposed on the first substrate end surface.

14. The optical connection component according to claim 1,
wherein each of the cores has a shape extending from the first substrate end surface toward the second substrate end surface, a first core end surface located near the first substrate end surface, and a second core end surface located near the second substrate end surface,
wherein each of the first core end surfaces is positioned on the first substrate end surface,
wherein each of the second core end surfaces is positioned inside the glass substrate so as to be spaced apart from the second substrate end surface by a certain distance,
wherein the second substrate end surface is configured to function as a reflective surface, and
wherein each of the first lenses is disposed on a third substrate end surface included in the surface of the glass substrate, the third substrate end surface being located between the first substrate end surface and the second substrate end surface, in a state in which each of the first lenses is optically coupled to a corresponding one of the cores via the second substrate end surface.

15. The optical connection component according to claim 1,
wherein the number of the cores is three or more, and each of the cores has a shape extending from the first substrate end surface toward the second substrate end surface, a first core end surface located near the first substrate end surface, and a second core end surface located near the second substrate end surface,
wherein the second substrate end surface is configured to function as a reflective surface and inclined with respect to the first substrate end surface,
wherein the second core end surfaces are arranged two-dimensionally inside the glass substrate so as to be spaced apart from the second substrate end surface by a certain distance when the second core end surfaces are viewed from the second substrate end surface toward the first substrate end surface and such that optical path lengths from the second core end surfaces to the respective first lenses, via the second substrate end surface, coincide with each other, and
wherein each of the first lenses is disposed on a third substrate end surface included in the surface of the glass substrate, the third substrate end surface being located between the first substrate end surface and the second substrate end surface, in a state in which each of the first lenses is optically coupled to a corresponding one of the cores via the second substrate end surface.
